(19) United States
(12) Patent Application Publication
(10) Pub. No.: US 2012/0054058 A1
(43) Pub. Date: Mar. 1, 2012

(54) METHOD OF MATCHING ASKS AND BIDS OF TAILORED VIDEOS

(75) Inventor: Gian Luca PETRELLI, Milano (IT)

(73) Assignee: BEMYEYE S.R.L., Milan (IT)

(21) Appl. No.: 13/182,048

(22) Filed: Jul. 13, 2011

Related U.S. Application Data
(60) Provisional application No. 61/363,860, filed on Jul. 13, 2010.

(51) Int. Cl. G06Q 30/08; G09B 25/00

(52) U.S. Cl. 705/26.3; 434/365; 705/27.2

(57) ABSTRACT

A method for matching buyers willing to pay for tailored videos or pictures of a faraway place and sellers willing to get paid for taking a video or picture with their smartphone in a nearby location may include the use of a map-based graphic user interface which shows bids and asks posted by user. The interface includes requests for live videos from buyers and real time location of sellers available for shooting a live video. Also, bids of videos or pictures for sale may be published using the interface on the basis of a shooting location and requests may be posted for recorded videos or pictures to be received at a later time. Tools for remotely directing the video when streamed in real time and the means to prevent misuse by tagging the video or picture with a unique identification code are provided. A service provider may manage the service in a server based architecture dealing with payments.

### CROSS-REFERENCE TO RELATED APPLICATIONS

This application claims priority to U.S. Provisional Patent Application Ser. No. 61/363,860, filed Jul. 13, 2010, the entire disclosure of which is incorporated herein by reference.

### BACKGROUND OF THE DISCLOSURE

The need of accessing visual information of a remote location has been fulfilled in better ways with the evolution of technologies. Existing art evolved from printed images through television broadcasting up to nowadays tools like video streams on the Internet, either recorded (e.g. YouTube) or in real time (e.g. webcams or live broadcasts). As far as many potential viewers bear an interest in a video there is a chance that somebody will make it and broadcast it.

Existing art less fulfils the need of accessing updated visual information of a faraway location when there is only one person potentially interested in it. Some examples of this specific need can be: 1) an investor that would like to have an idea of a neighbourhood before a preliminary real estate decision; 2) a tourist wanting an up to date and non-biased view of an hotel area before paying for a vacation; 3) a food manufacturer that wants to know how his product is displayed in another country's supermarket 4) the owner of a boat moored in a faraway harbour that wants to check damages after a sea storm 5) a person interested in a faraway event that will not be broadcasted in real time or will not be broadcasted at all.

A partial solution offered by existing art is a tool named Google StreetView where still images of several locations are available. Images can be quite old and only show the streets of the main cities. Another partial solution is represented by mobile Multimedia Messaging Service (MMS) or video phone calls that can provide better tailored visual information than StreetView but require knowing a counterpart in the desired place.

If nobody is known in the faraway location, the existing art does not allow accessing updated or real time visual information when only one person bears an interest in that place.

### SUMMARY

With the spreading of mobile terminals such as mobile phones ensuring enhanced processing power and video capturing capabilities (e.g. so-called smartphones) together with the increasing bandwidth available in mobile telecommunication networks and with the decreasing cost for data transmission, shooting a video or picture in any moment and streaming it in real time will be more and more common.

Various embodiments here described aim at solving the problems in existing art discussed above e.g.: i) by matching people bearing a personal interest in a place with those that can provide an updated visual information of it; ii) by giving the tools to remotely direct a live video.

Various embodiments allow having a tailored video or picture shot by initiative of the person with an interest in it rather than by initiative of the person that makes it. This can solve the need to access tailored visual information of a faraway place when nobody is known there.

Various embodiments also overcome existing art when a video or picture is available but the potential viewer finds it too expensive or not enough tailored and wishes to find an alternative source (e.g. a journalist wanting a tailored video of a flood in a distant country without buying it from the local television news).

Various embodiments may organize the interaction of three subjects: i) a service provider (“SP”) that supplies an application for mobile terminals such as e.g. smartphones (“App”) and a website both including a map-based graphic user interface (“Map”) showing bids and asks posted by users; ii) a user (“Eye”) willing to sell images he recorded (pictures or videos) or willing to sell his time for taking a live video with his mobile terminal of a nearby place; iii) a user (“Tenant”) willing to pay for receiving a picture, recorded video or real time video of a faraway location.

A preferred embodiment includes several possible situations:
“Live Bid”: an Eye available to stream a live video of a nearby location publishes on the Map its price and real time position.
“Live Ask”: a Tenant willing to see a live video of a particular location publishes on the Map the description of the job and the price offered.

Other possible embodiments may also include:
“Rec Bid”: an Eye willing to sell a picture or video of a particular location publishes on the Map a “demo” with the price requested and an appropriate description.
“Rec Ask”: a Tenant willing to commission a picture or video of a particular location (to be received at a later time) publishes on the Map the price offered and the description of the job.

### BRIEF DESCRIPTION OF THE DRAWINGS

FIG. 1 is a flowchart depicting the method of a Live Bid in accordance with the present invention;

FIG. 2 is a flowchart depicting a method of a Live Ask in accordance with the present invention;

FIG. 3 depicts a web image of multiple Live Bids and Live Asks as in FIGS. 1 and 2;

FIG. 4 depicts examples of communications between an eye and a tenant in accordance with the methods in FIGS. 1 and 2;

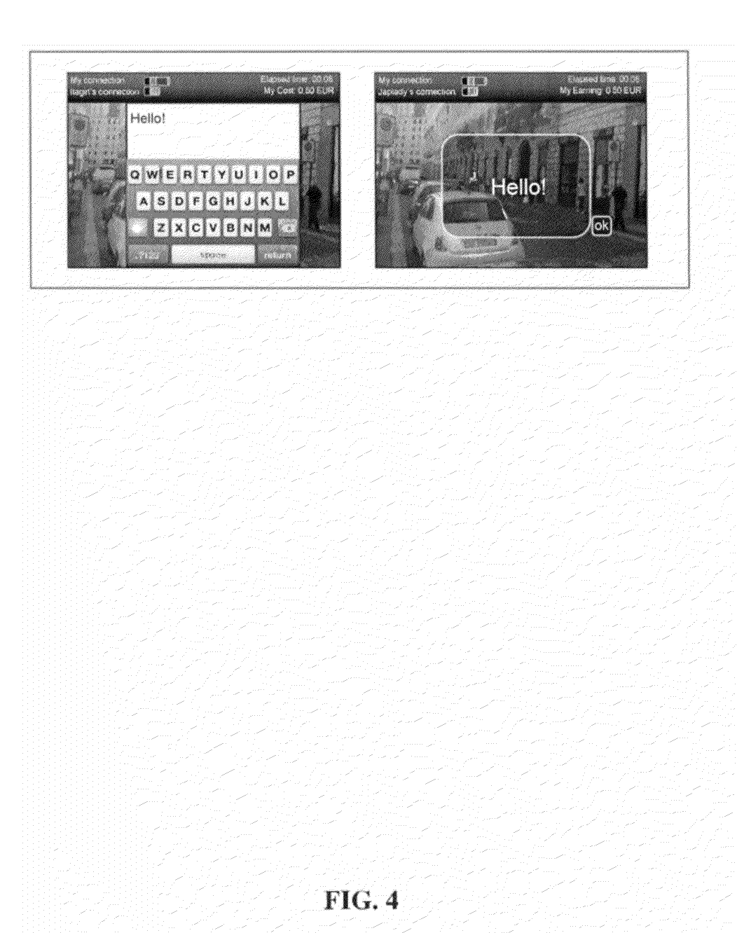

FIG. 5 depicts further communications between an eye and a tenant in accordance with the methods of FIGS. 1 and 2;

FIG. 6 depicts further communications between a tenant and an eye as in the method of FIGS. 1 and 2;

FIG. 7 depicts an image of a video being tagged with a unique identification code in accordance with the present invention;

FIG. 8 depicts the locations of a live webcam and a recorded video in accordance with the present invention;

FIG. 9 depicts a flowchart describing a method for a Rec Bid in accordance with the present invention; and

FIG. 10 depicts a flowchart describing a method for Rec Ask in accordance with the present invention.

### DETAILED DESCRIPTION OF THE DRAWINGS

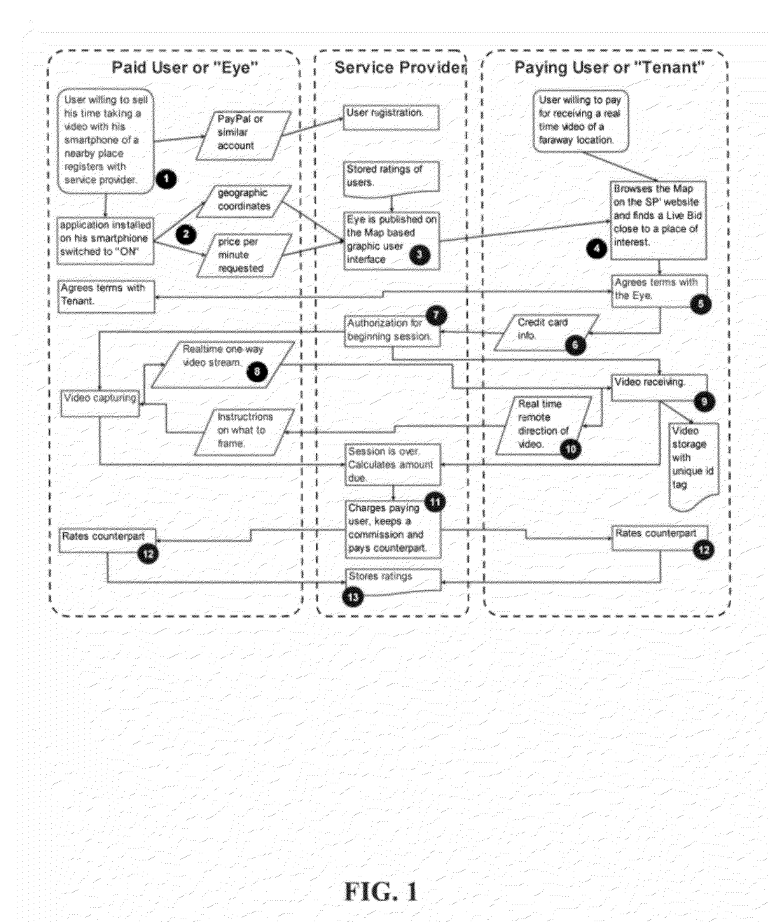

Flowchart 1 (FIG. 1) summarizes an exemplary case of a “Live Bid”:
1) The Eye installs the App on his mobile terminal (hereinafter a smartphone will be considered as exemplary of such a terminal) and registers with the SP, e.g., providing an account where he can be paid (e.g. PayPal).
2) The Eye switches the App to “on” and “service” information such as e.g. his price per minute and geographical coordinates are sent to the SP.
3) The SP publishes on his Map a symbol named “Live Bid” (e.g. a “Pinpoint”) showing e.g. in real time the position of that Eye together with his price. If the Eye is a returning user rating information may also be published.
4) A Tenant logs to the SP website whether from a computer or smartphone. He browses the Map looking for a Live Bid in a location for which he bears an interest. If more than one Live Bid appears close to the place of interest he can choose depending on e.g. location, price and rating.
5) The Tenant can contact the Eye corresponding to the chosen Live Bid (e.g. via instant messages allowed by the App), in order to agree the terms of the required shooting.
6) Before proceeding, the Tenant may give his credit card information (or any similar information) to the SP.
7) The SP allows the beginning of a video session.
8) The smartphone of the Eye starts streaming a video to the Tenant. In this exemplary embodiment, the video is not stored on the Eye's smartphone.
9) In this exemplary embodiment, the video received by the Tenant in real time is automatically stored on his device and tagged with a permanent and unique identification number (e.g. IP address, date and time). In other embodiments the video may be stored on the servers of the SP.
10) The Tenant may remotely direct the shooting having texts and symbols appearing on the screen of the Eye.
11) When the session is over, the SP may charge the Tenant and pay the Eye.
12) The Eye and the Tenant may give a rating to the counterpart.
13) The SP may store the rating.

The Tenant may be the only owner of the video. If this becomes public and legal liabilities emerge, the unique tag can be traced back to the Tenant's and Eye's identity.

It will be appreciated that payments might be done without a SP and/or that SP may not deal with the payment.

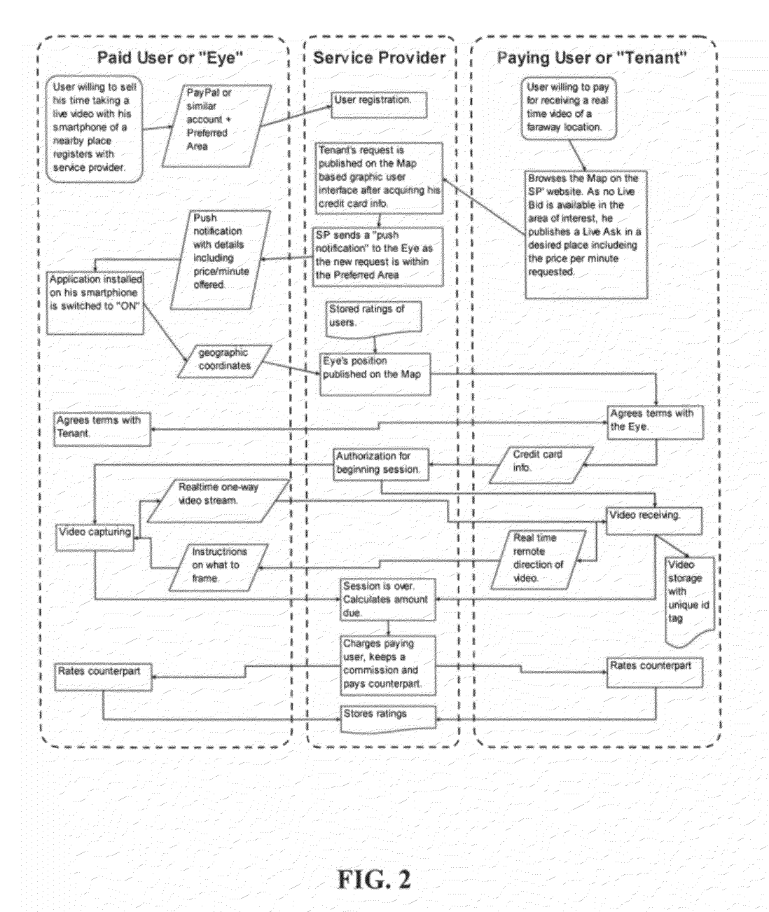

Flowchart 2 (FIG. 2) summarizes the exemplary case of “Live Ask”. When a Tenant, looking for an Eye in a particular place on the Map, doesn't find any counterpart, he can publish on the SP's Map a pinpoint named “Live Ask” with the details of his request, e.g. its expiry date and the price per minute he is willing to pay. The Tenant's Live Ask may be published by the SP in the Map together with his eventual rating and can be seen by all Eyes.

In this embodiment each Eye—when first subscribing to the service—must set his Preferred Area that will be stored by the SP (e.g. a circle with centre on his home and radius of 3 Km.). When a new “ask” is posted within the area of a particular Eye, the SP sends to his smartphone a “push notification” with the details of the request. If that Eye is close to the place where the “ask” was posted, he can choose to turn his App to “on” and propose himself to that Tenant.

In this embodiment, if an Eye turns his App to “on” after a Tenant's request, the Tenant will see a pinpoint appearing on the Map and representing that Eye. The Tenant will then be able to see the exact position of that Eye together with his past ratings and other information. The Tenant and Eye will interact via instant messages in order to agree the terms of the required shooting. Flowchart 2 (FIG. 2) shows how the transaction from this point follows the same steps of the Live Bid in Flowchart 1 (FIG. 1).

In various embodiments both Live Bids and Live Asks may benefit from a software application that allows to remotely control in real time the direction of a live video taken with a mobile terminal such as a smartphone. This remote direction consists of texts and symbols sent by the Tenant and appearing in real time on the Eye's smartphone in order to instruct him on what to frame or where to go. With existing art the only way to achieve such a result would be:
A long distance phone call that, besides the cost, requires disclosing the telephone numbers of the counterparts.
Voice over IP (VoIP) that, besides its bandwidth consumption, would represent a more invasive way to direct the Eye.

This remote direction made of a combination of texts and graphics can obtain the same result of voice instructions while avoiding the drawbacks of existing art.

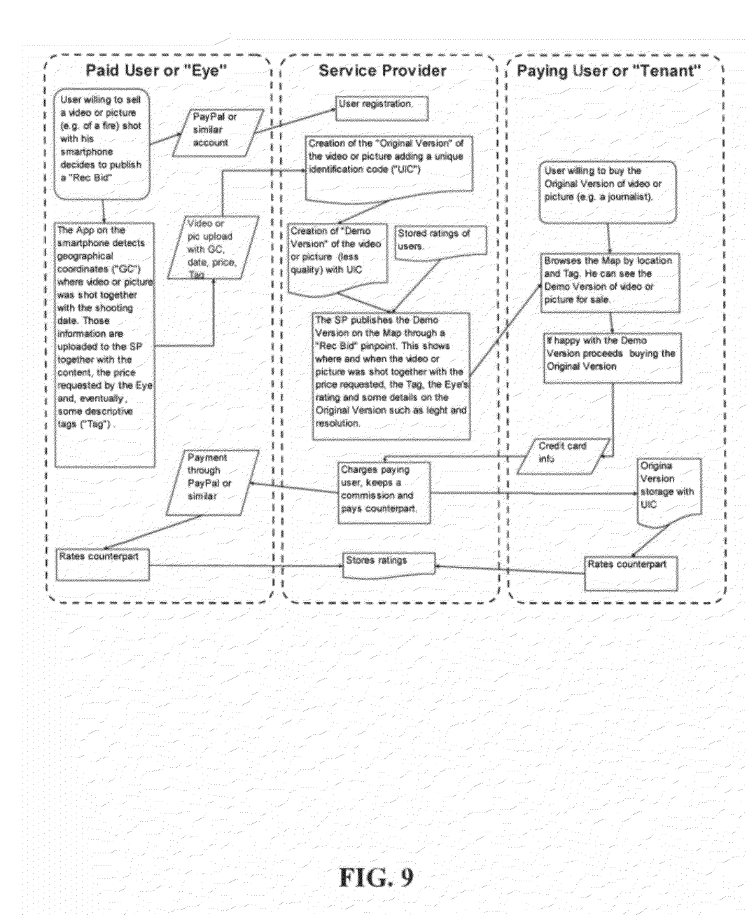

Flow Chart 3 in FIG. 9 depicts an example of a “Rec Bid”. When an Eye happens to witness an event of potential public interest (e.g. a fire or a car accident) he may decide to take a video or a picture with his smartphone in order to sell it to the media. The “Rec Bid” embodiment here described includes an Eye uploading a video or a set of pictures together with a description of the content, the date and place where it was taken and the requested price. After the upload, the SP publishes on the Map a pinpoint visible by any user accessing the SP's website. The pinpoint will let any user see a low resolution version (“Demo”) of the uploaded content. Content in original high definition will be available just when purchased.

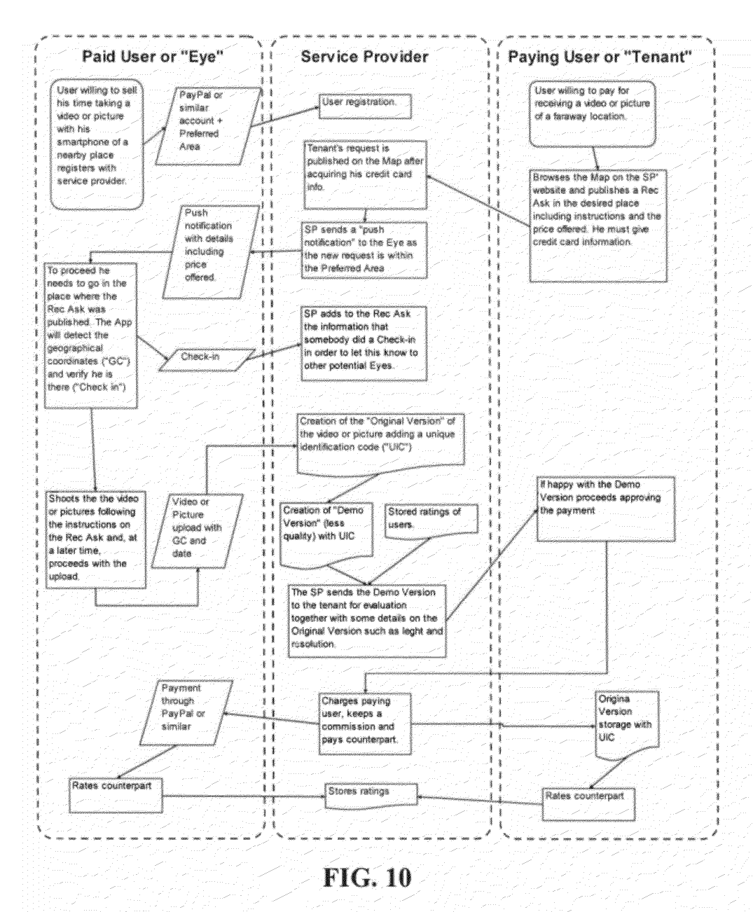

Flow Chart 4 in FIG. 10 depicts an example of a “Rec Ask”. When a Tenant wishes to receive images of a remote location but is not interests in a real time video, he can publish on the Map a request for pictures or a video (to be received at a later time) including the price offered and a description of the job. An Eye in the vicinity of the Rec Ask will receive a “push notification” from the SP. If the Eye wants to pick that request he will have to go to the exact location, testify through the App his presence (“check-in”), take the pictures or video and upload the content. The Tenant will receive a Demo and, if satisfied, will tell to the SP to release the payment to the Eye.

In various embodiments, the method here described may include the feature of tagging the remotely saved video with a unique and permanent identification number in order to prevent the misuse of the tool.

### DETAILED DESCRIPTION OF THE INVENTION

Various exemplary embodiments essentially involve a service provider (SP) performing steps such as e,g.:
distributing the App and managing the website to be used by counterparts;
publishing the bids and asks on the Map together with the ratings of the users;
alerting an Eye of a new available “ask” in his area;
managing the payment;
giving the tools to remotely direct the video shooting without a phone call.

In various embodiments the SP may not deal with the one-way video stream and the communications between counterparts. Both these streams of data can be managed in a peer-to-peer architecture or in a server-based architecture.

Various embodiments will now be considered by referring to two examples:
An Eye is contacted by a Tenant from Live Bid
A Tenant is contacted by an Eye from a Live Ask

For the first example we will consider a user in Milan (that we'll call “Itagirl”), willing to sell a few minutes of her time to show a nearby location, and another user in Tokyo, (“Japlady”), willing to pay for a real time look at the shop windows in Milan e.g. to decide what she may wish to purchase on the occasion of a future trip to Milan.

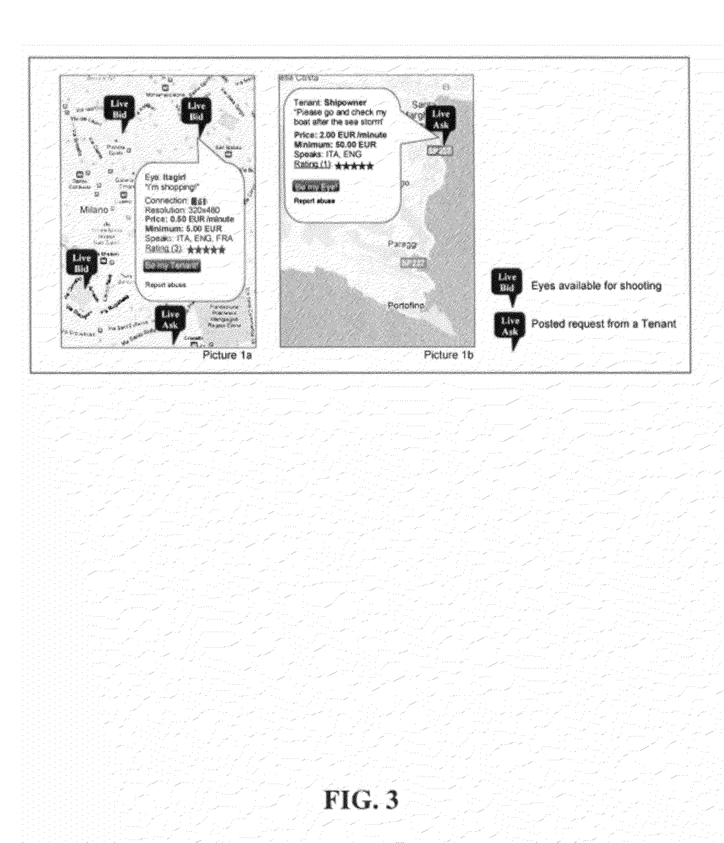

Itagirl owns a Smartphone where she installed the App. She's been playing as an Eye in the past and the service provider already stored her payment information (e.g. PayPal) and the received ratings. As she has some spare time, she switches the application to “on” and decides that her price per minute is e.g. 0.50 EUR with a minimum of e.g. 5.00 EUR. She also writes a short message (e.g. “I'm shopping!”). That information together with her geographic coordinates is published on the Map with the shape of a pinpoint marked with “Live Bid”. All users can browse the Map and see the real time position of Itagirl. By clicking the pinpoint (Picture 1a of FIG. 3) the information given may include e.g.:
her short message;
the quality of her connection;
the resolution of her smartphone;
her price per minute and minimum price;
the languages she speaks;
her past ratings;
a button for connecting her;
a “Report Abuse” link.

Japlady is at her computer connected to the internet and logged to the service SP's website. She browses the Map and sees that several Eyes are available for shooting a video. She sorts them depending on rating, price and smartphone resolution. At the end she decides to contact Itagirl. Before proceeding she must give to the SP her credit card number together with the maximum amount she's willing to spend (e.g. 20.00 EUR) and a short message for Itagirl: “Hi, I'm from Japan and I'd like to see what's sold at shop XY in ZZZ Street. Do you have time now?”.

The service provider checks—but does not yet debit—the maximum amount set. If the check is fine the service provider sends to Itagirl the request from Japlady. If the Eye agrees, the service provider can allow the beginning of the video session.

Itagirl starts shooting a video and streaming it to Japlady in real time. They both see the same images. Depending on the embodiment, the SP may or may not deal with the video transmission but sends to both parties information on elapsed time and cost of service.

Japlady can send short messages to Itagirl that sees them overlaying the video (FIG. 2). The short messages needs to be closed clicking “ok” thus ensuring they have been read. Itagirl does not need to write messages as Japlady can hear her talking. In embodiments where audio is not included in the video stream, the Eye will have to type his replies to the Tenant.

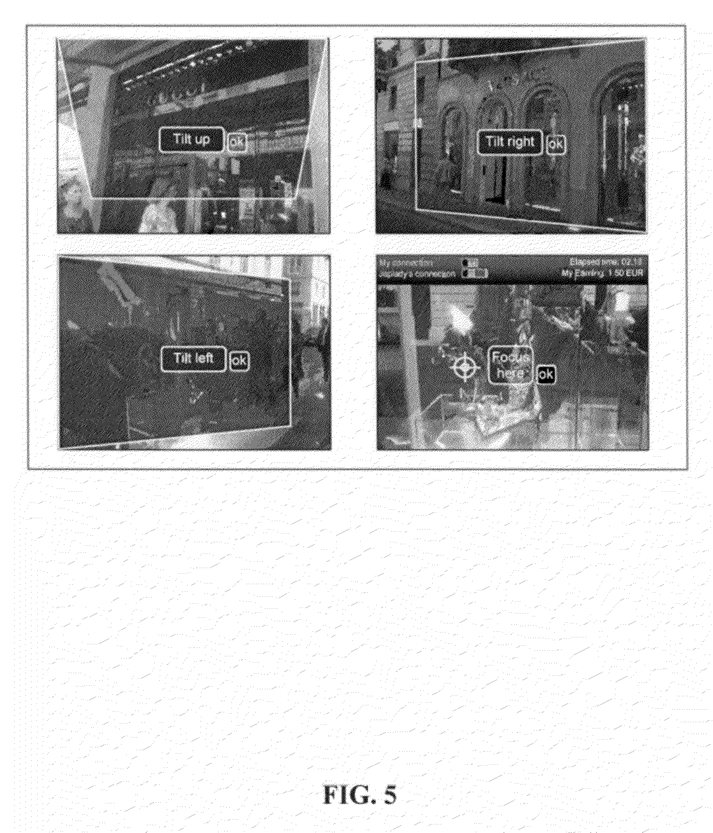

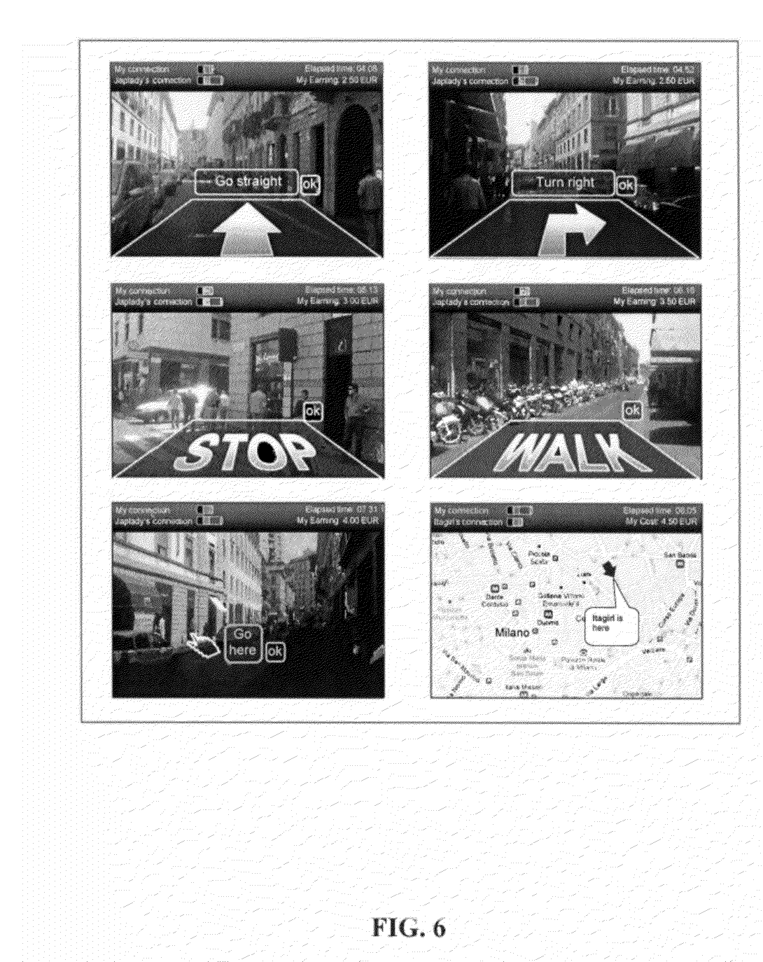

Japlady can give instructions on what should be framed by texts or graphics appearing on the screen (FIG. 5). Graphics include three dimensional planes to change the inclination of the shooting and a moving viewfinder. Japlady can also send other graphic-based instructions to have Itagirl walking in a certain direction (FIG. 6). Japlady can switch the view from the live video to the Map to check the real time position of Itagirl.

When Japlady is satisfied with the video (or one of the counterparts looses the connection, or the maximum cost set by the Tenant is reached), the service provider acknowledges that the session is over and calculates the amount due. The cost, plus a commission, is debited to the credit card of Japlady and, after a few days, funds are transferred to the PayPal account of Itagirl. Both users can rate the counterpart and the information is stored by the service provider.

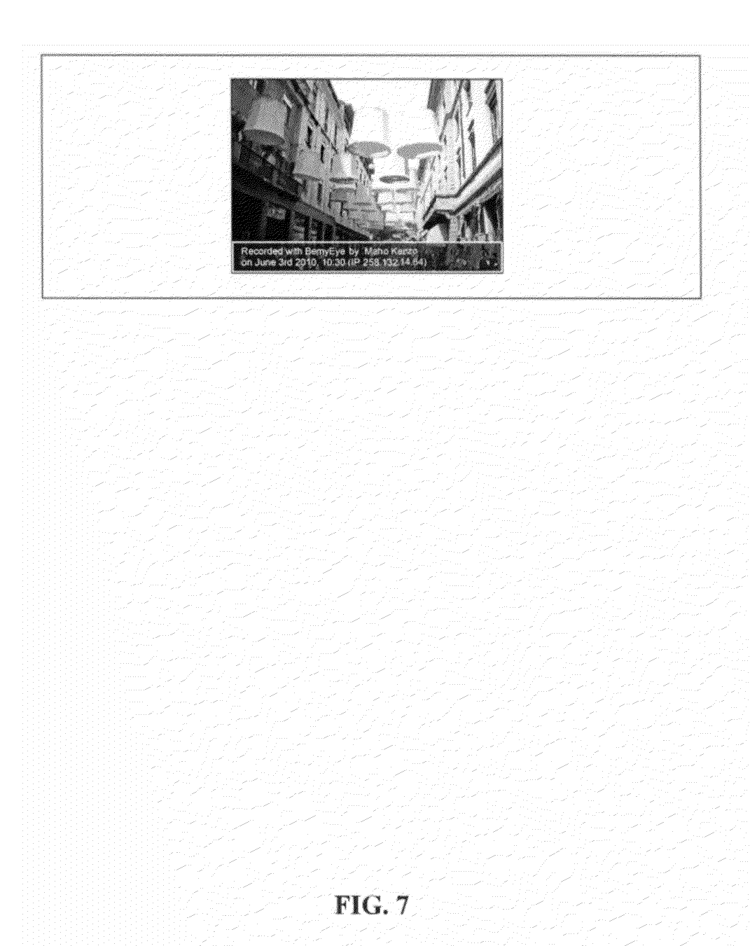

The resulting video may not show the texts and graphics sent during the shooting. It may be automatically saved on Japlady's computer or on the servers of the SP. The video is permanently tagged with a unique identification code (FIG. 7). This ensures that, if the video becomes public, the Tenant and the Eye remain responsible for it. Different embodiments can have a Tenant using the service just from a computer or even from a smartphone or other devices.

A second example can be a ship owner that needs to know e.g. if a recent sea storm damaged his boat moored in a faraway harbour. He needs to understand the situation but he doesn't know anybody there that can make pictures and send them via e-mail or MMS. He checks the Map on the website of the SP and notices that there is no Eye in the area. He then decides to post a “Live Ask” hoping that somebody will collect it. It's a very important and urgent issue for him and for this reason he is willing offer e.g. 2 EUR per minute with a minimum of e.g. 50 EUR if somebody goes there and shoots for him a video of the damages.

The boat owner publishes his request after sending his credit card information to the SP together with the minimum and maximum he is willing to spend. He also sets an expiry date for his ask (e.g. 7 days) and publishes a message (e.g. “Please go and check my boat after the sea storm”). All the users can then see a pinpoint in the Map describing the Ask of this Tenant (Picture 1b). In particular the “Live Ask” marked pinpoint will show e.g.:
his message;
the price per minute he is willing to pay and the minimum price offered;
the languages he speaks;
his rating;
a button to connect him;
a “Report Abuse” link.

After the new ask is published on the Map, the SP checks if those coordinates are within the Preferred Area of one or more Eyes. The SP will let the Tenant know if the place where he posted his “Live Ask” is actually included in the Preferred Area of any Eye. In this example we assume that this is the case and the SP sends a “push notification” to the smartphone of an Eye living close to the harbour. As this Eye receives the notification he turns the App to “on” and his position is then published through a pinpoint on the public Map and can be seen by the boat owner.

When both parties agree, the service provider allows the beginning of the session bringing back the situation described in the first example.

Using the remote direction of the video, the boat owner is able to view the details that he needed to see as if he was personally there.

It has to be noted that, in various embodiments, Tenants or Eyes do not need to know the counterpart's identity nor telephone number.

In order to discourage the misuse of the method (e.g. bids for stripteases, asks to spy a third party, circulation of copyrighted images) various embodiments may include security tools such as:
The possibility to make the video only from the back camera of the smartphone thus making difficult the self shooting of the Eye;
“Report abuse” links for inappropriate bids or asks published on the Map; and/or
a unique identification tag permanently associated to the recorded video.

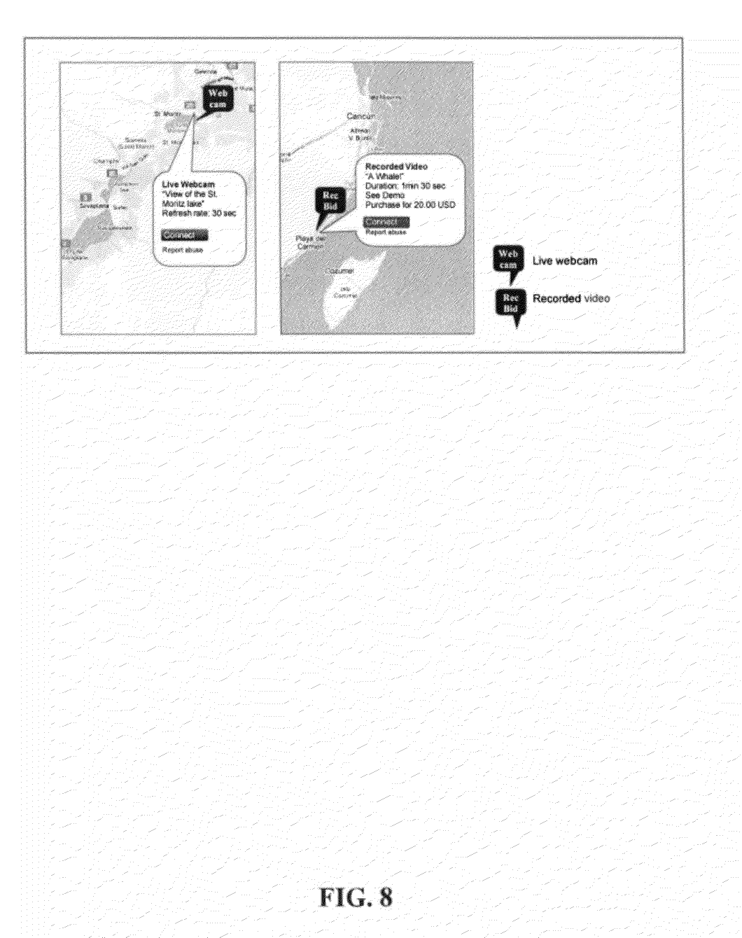

Various embodiments may include having other types of pinpoint appearing on the Map (FIG. 8.) e.g.:
live webcams (e.g. for weather or traffic); and/or
recorded videos Bids and Asks (i.e “Rec Bids” and “Rec Asks”)

1. A computer-implemented method matching bids and requests for videos or pictures taken with mobile terminals.

2. A computer-implemented method comprising a map-based graphic interface, the method comprising showing two or more of the following:
i) posted requests for live videos from at least one buyer;
ii) a live location of at least one seller available for shooting a live video;
iii) videos or pictures for sale, published on the basis of a shot location where the videos or pictures for sale were shot;
iv) posted requests for recorded videos or pictures to be received at a later time.

3. The method of claim 1 further comprising a buyer remotely instructing a seller on what to frame in a video or a picture.

4. The method of claim 1, further comprising collecting payments from buyer and/or transfers to sellers.

5. The method of claim 1, further comprising providing means to find a counterpart depending on at least one of location, price, rating and signal quality.

6. The method of claim 1, further comprising seller and buyer remotely interacting to negotiate terms.

7. The method of claim 1, further comprising the video being streamed to the buyer only.

8. The method of claim 1, further comprising allowing a mobile terminal user or computer user to connect to live videos and/or recorded videos after searching for them on a map.

9. The method of claim 8, where the live videos or recorded videos are available at no charge in a demonstration and for a price in a complete version.

10. The method of claim 1, further comprising saving the video after being tagged with a permanent unique identification code.

11. A software application for use in remotely controlling the shooting of a video taken with a mobile terminal by having shooting instructions, such as text and/or symbols appearing on the screen of the video maker and sent from a remote director.

12. A software application configured to implement the method of claim 1.

13. The method of claim 2 further comprising a buyer remotely instructing a seller on what to frame in a video or a picture

14. The method of claim 2, further comprising collecting payments from buyer and/or transfers to sellers.

15. The method of claim 2, further comprising providing means to find a counterpart depending on at least one of location, price, rating and signal quality.

16. The method of claim 2, further comprising seller and buyer remotely interacting to negotiate terms.

17. The method of claim 2, further comprising the video being streamed to the buyer only.

18. The method of claim 2, further comprising allowing a mobile terminal user or computer user to connect to live videos and/or recorded videos after searching for them on a map.

19. The method of claim 18, where the live videos or recorded videos are available at no charge in a demonstration and for a price in a complete version.

20. The method of claim 2, further comprising saving the video after being tagged with a permanent unique identification code.
